(19) United States
(12) Patent Application Publication
(10) Pub. No.: US 2017/0124634 A1
(43) Pub. Date: May 4, 2017

(54) EZCloud Sales (ECS)

(71) Applicant: Bal Maraj, Fullerton, CA (US)

(72) Inventor: Bal Maraj, Fullerton, CA (US)

(21) Appl. No.: 14/926,550

(22) Filed: Oct. 29, 2015

(51) Int. Cl. G06Q 30/06; H04L 29/08

(52) U.S. Cl. CPC G06Q 30/0641; H04L 67/10

(57) ABSTRACT

This invention provides an easy to use cloud based ordering system which includes methods and rules in the embodiment of the applications to simplify the entire process of placing an order via the web portal. A system where authorized end/users are given access to a cloud based system interface to place order in the wholesaler's application 24/7 globally for authorized products via the web portal. The system allows for order cutoff date and time, it takes into consideration store inventory, sell through quantities, returns, stales and damage quantities. This entire process is to allow the end user to place a most efficient order which is beneficial to both the wholesale and the retailer. This method consists of rules based on wholesalers and customers business requirements. The system provides the end users/customers with immediate email notification in real time when they placed an order. The system/application is access through a user interface which makes the whole process easy quick and clean.

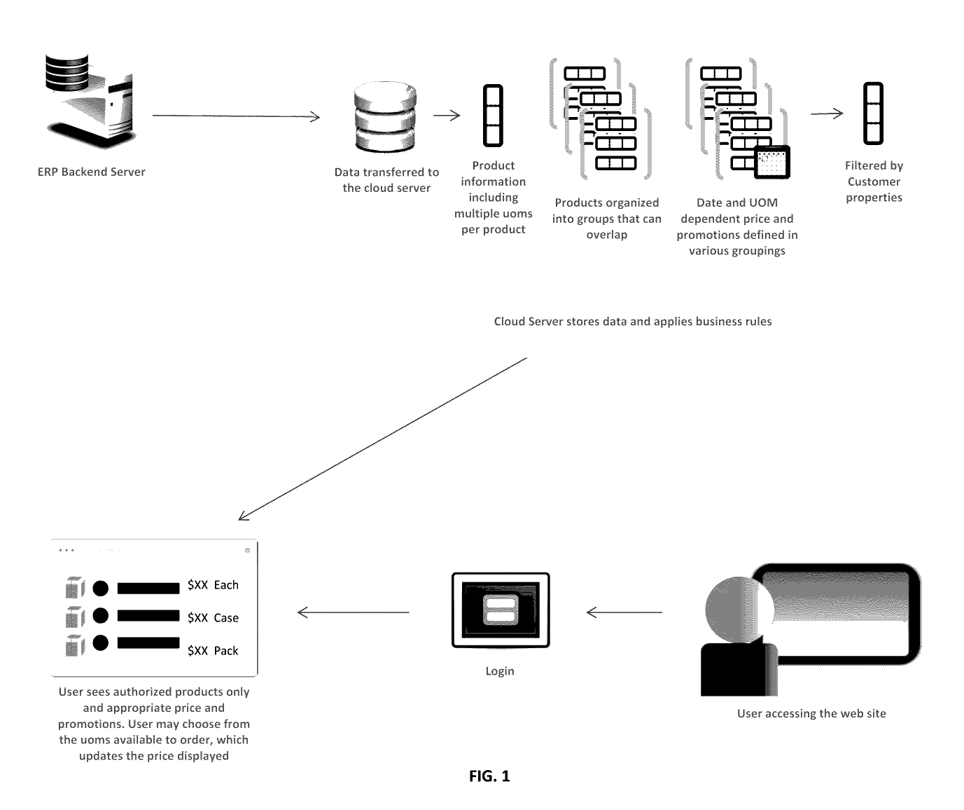

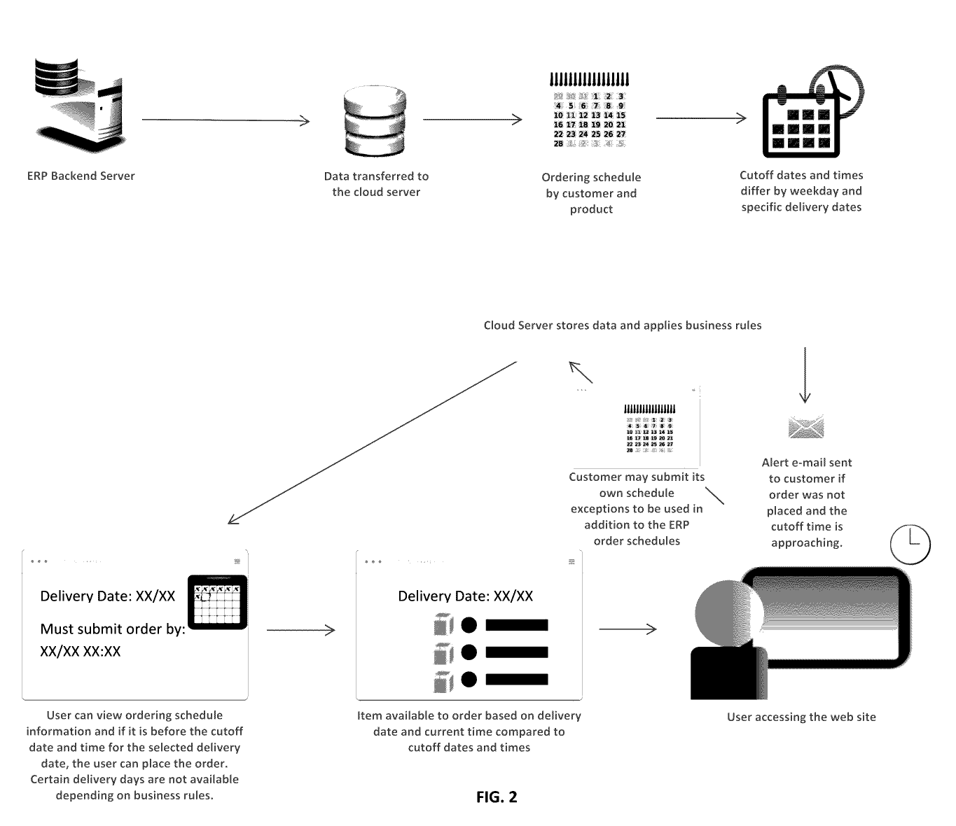

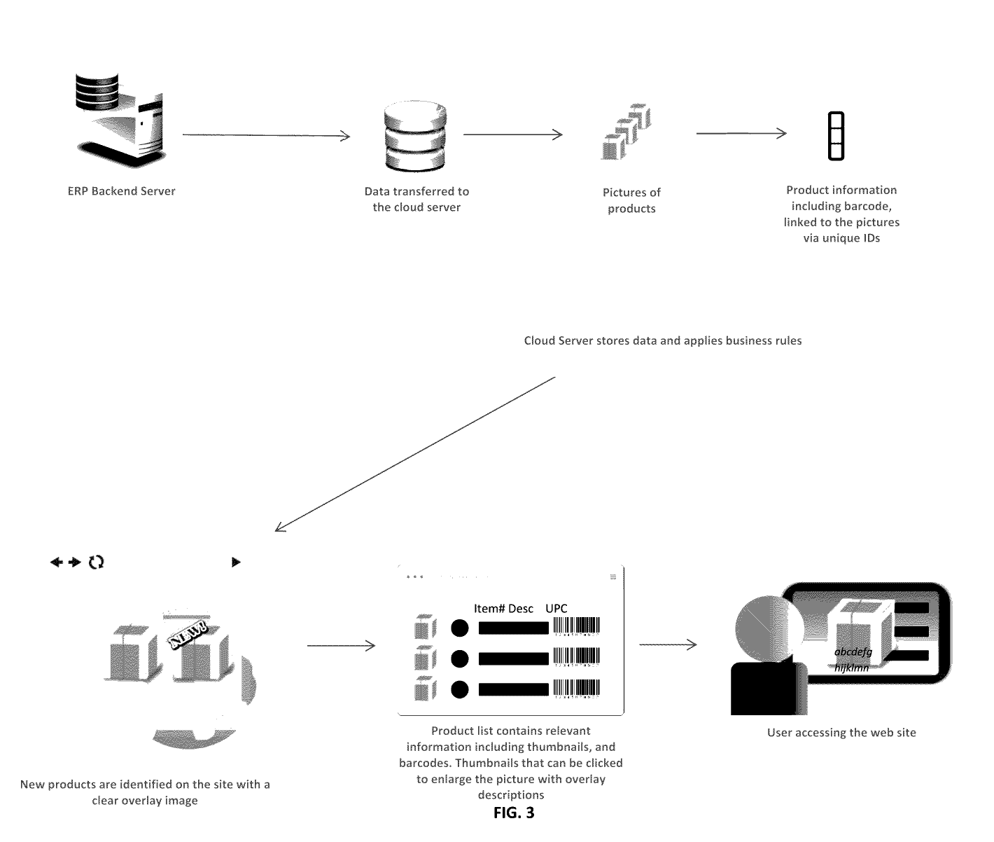

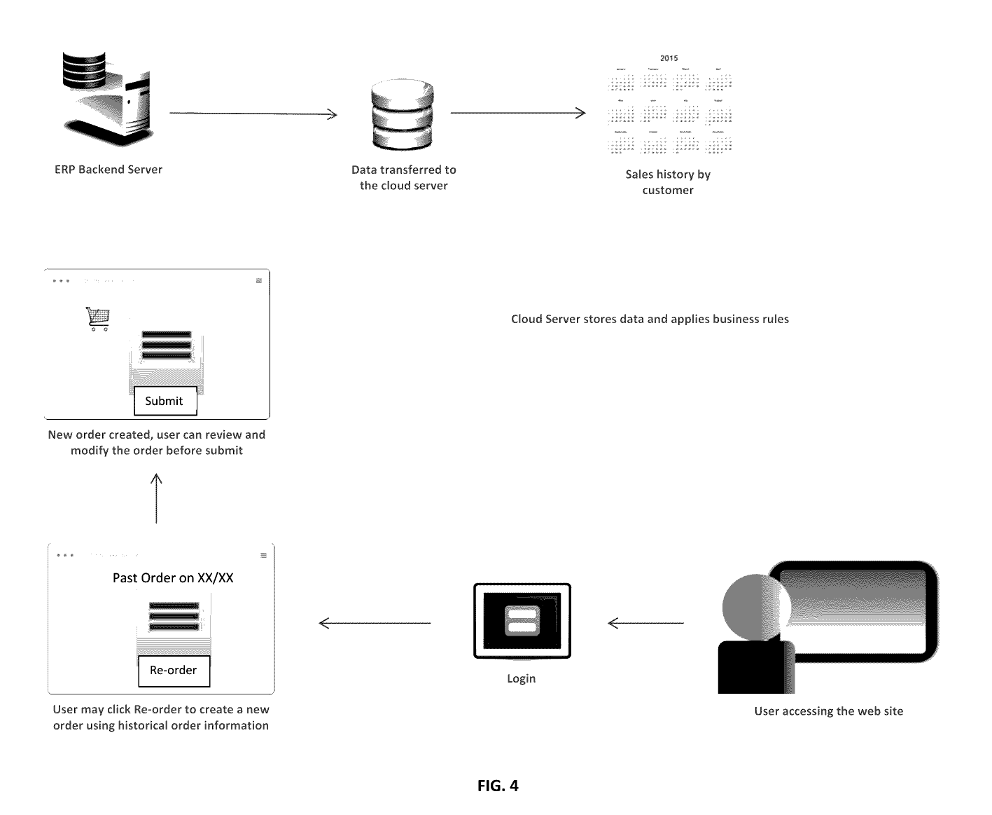

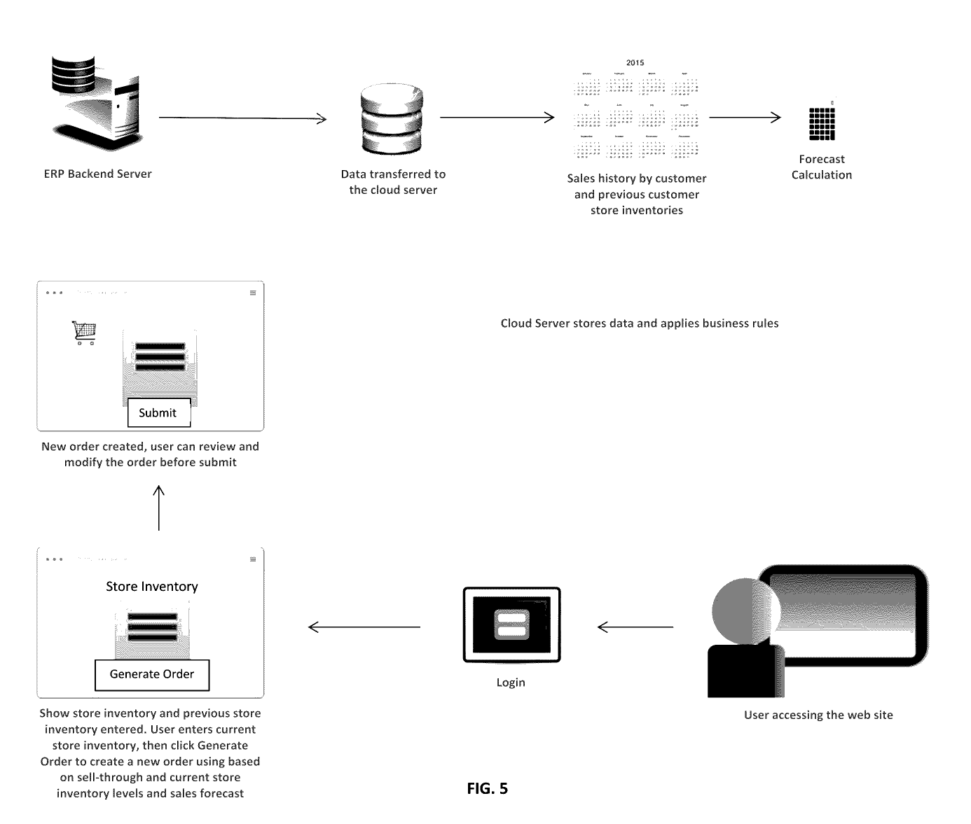

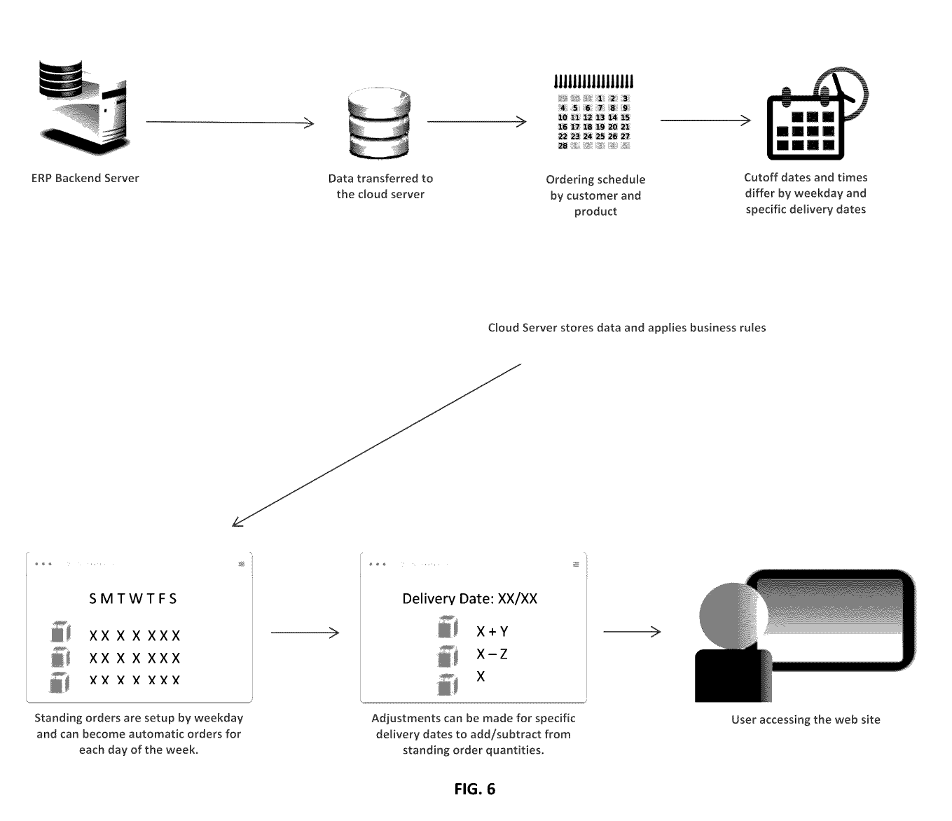

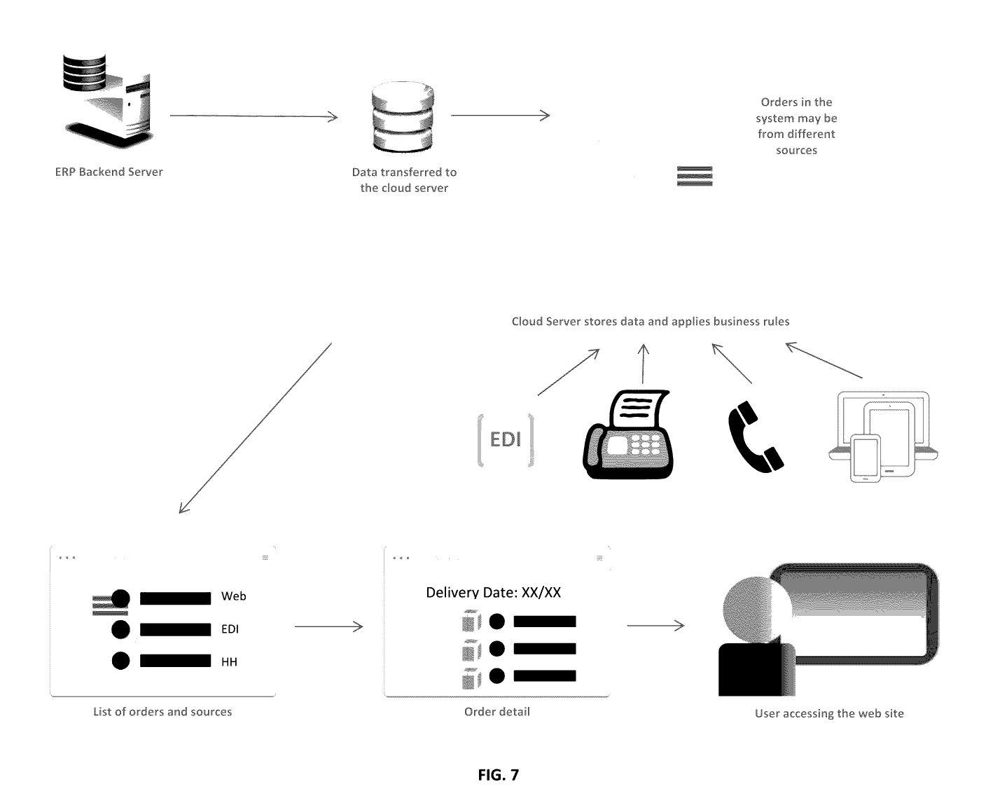

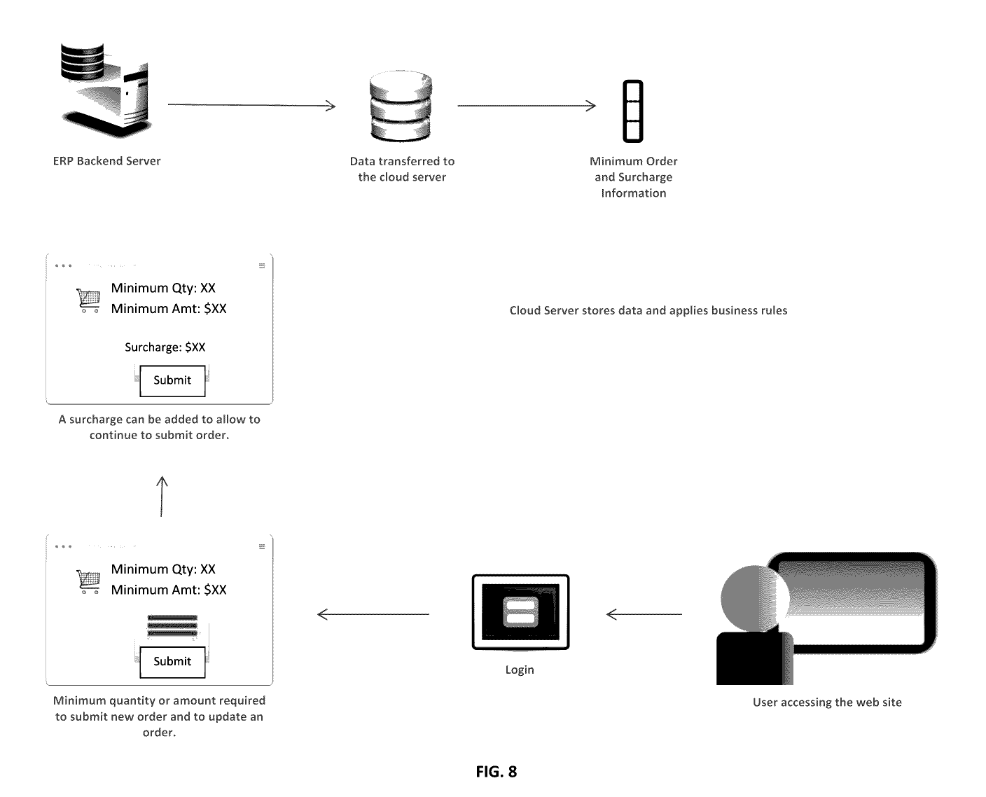

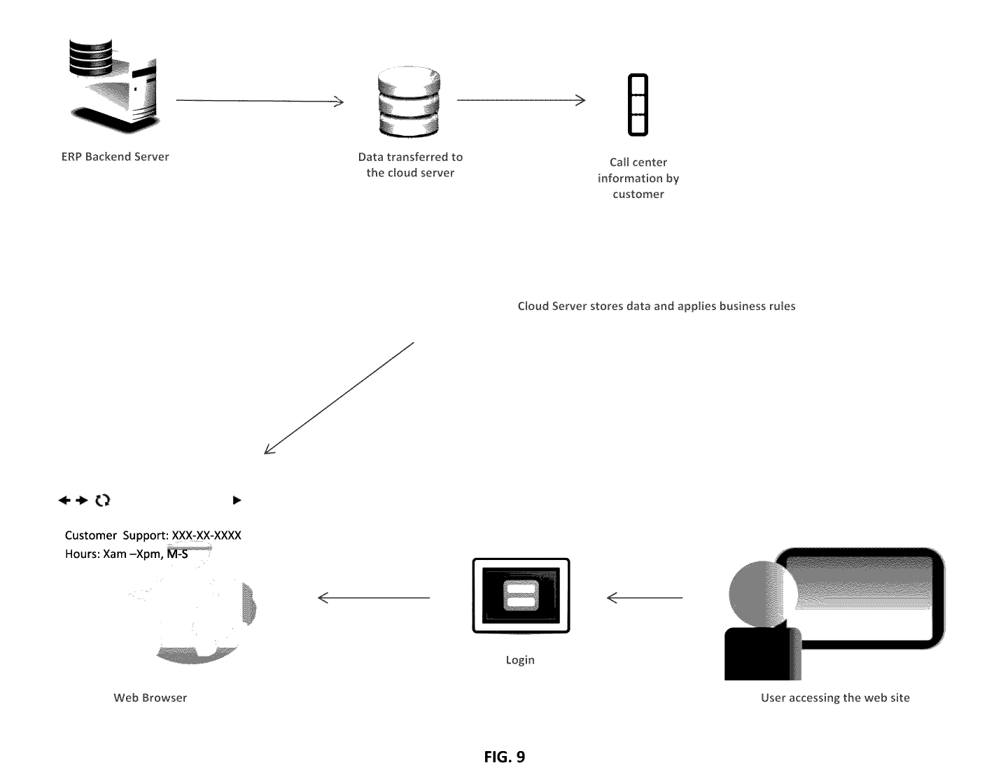

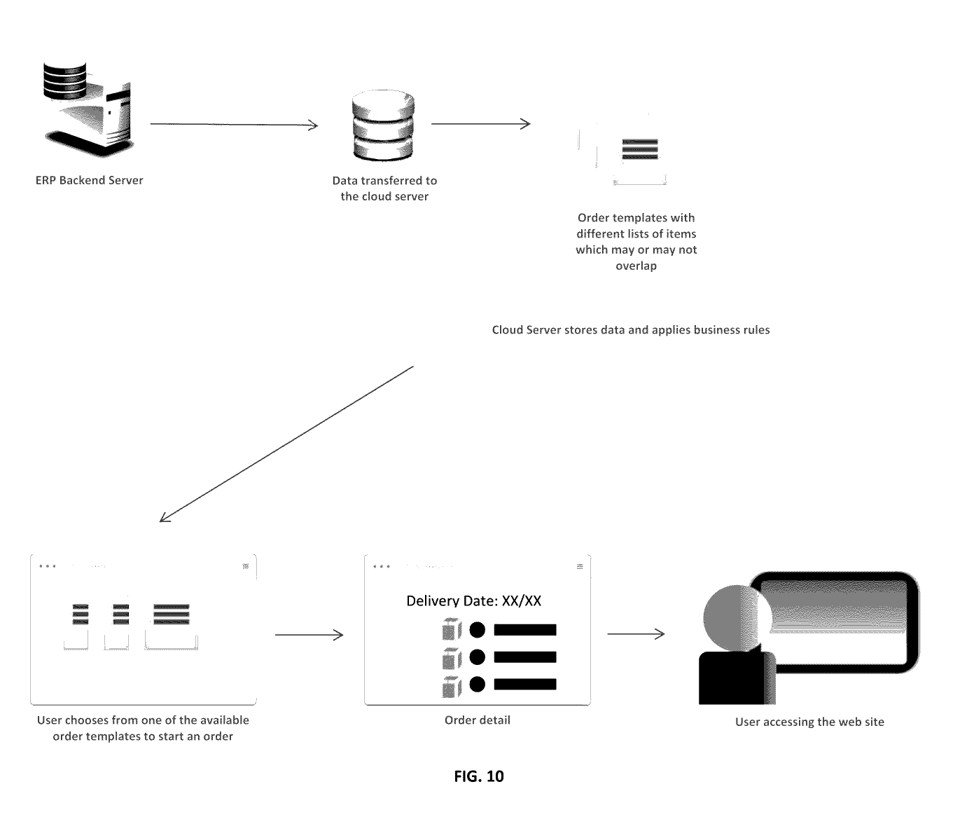

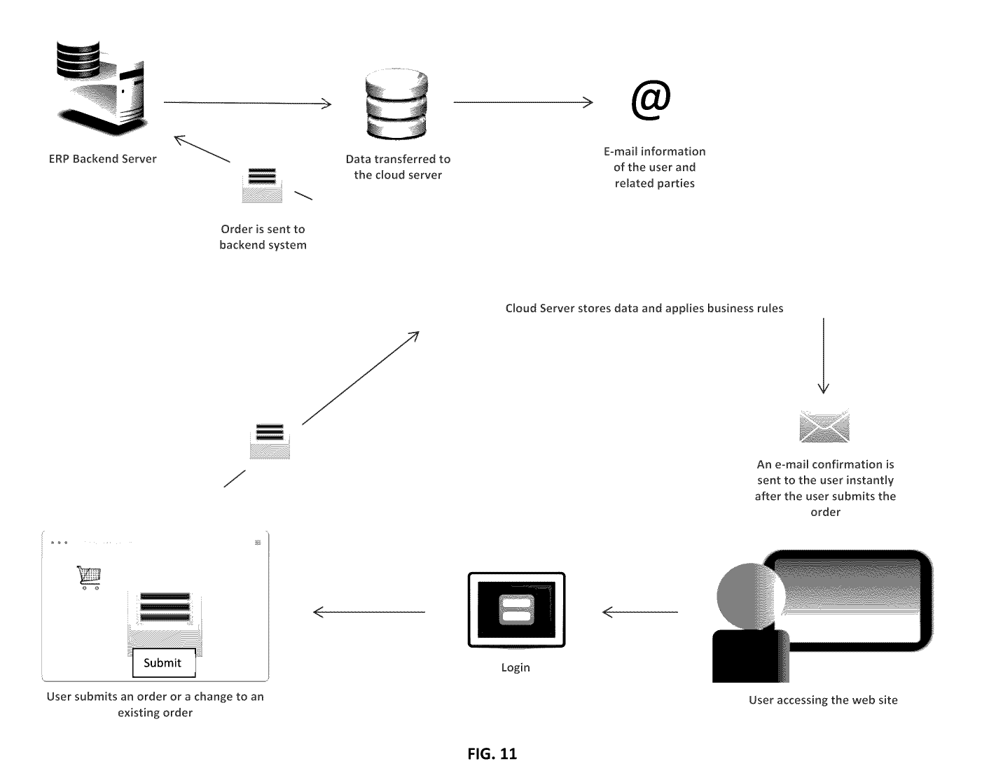

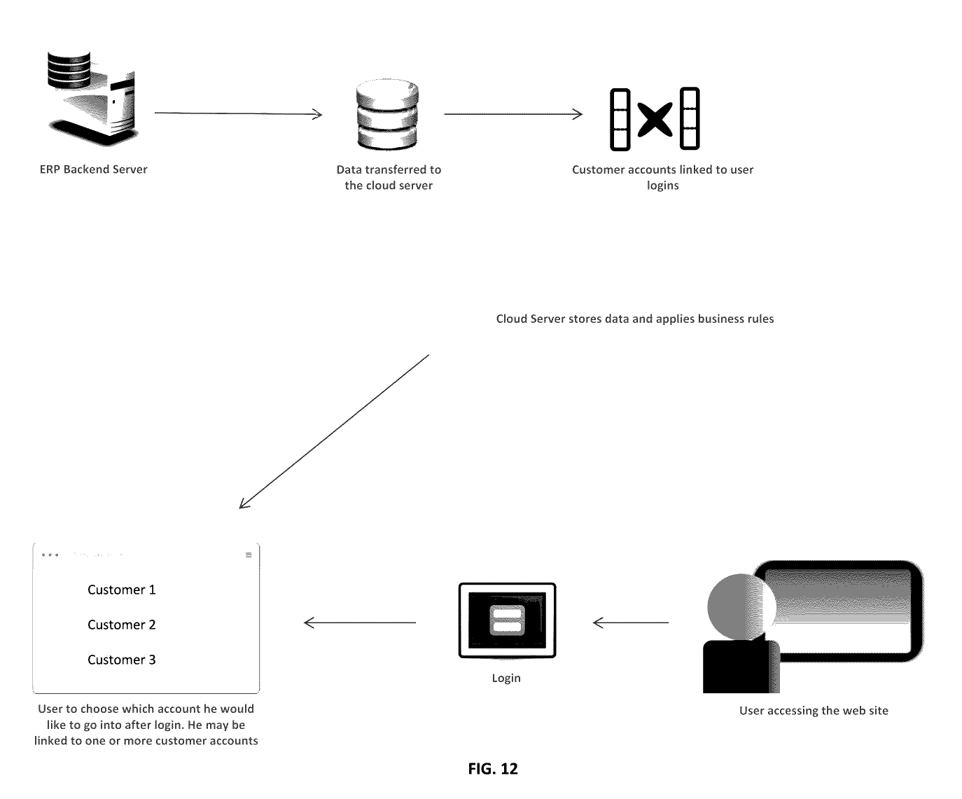

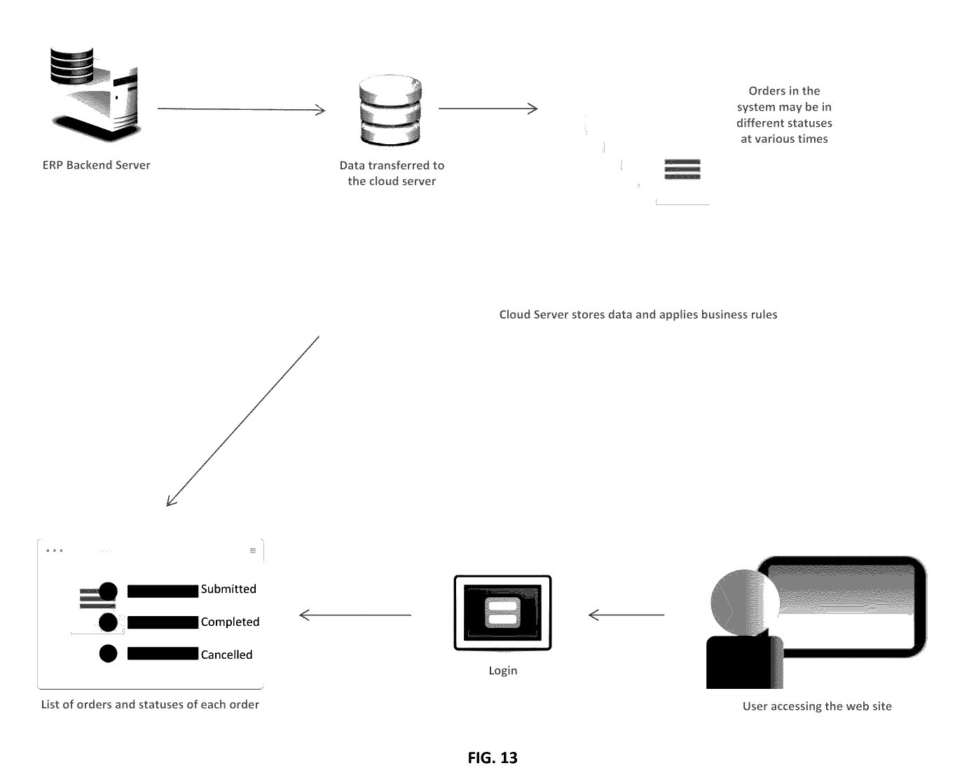

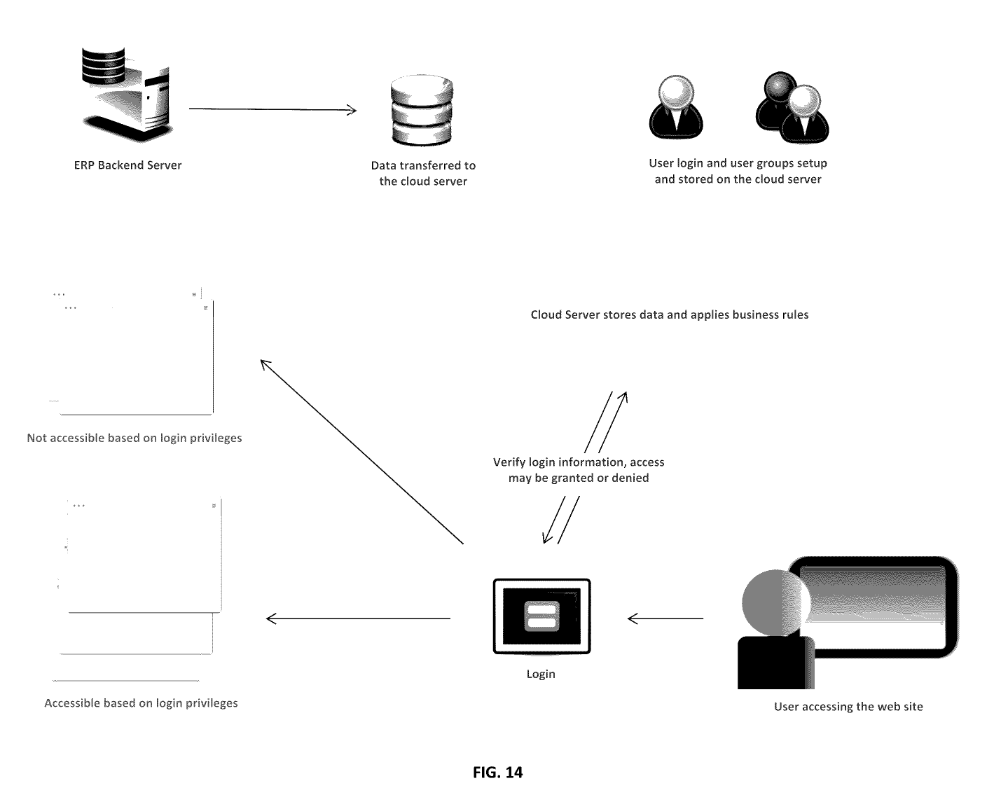

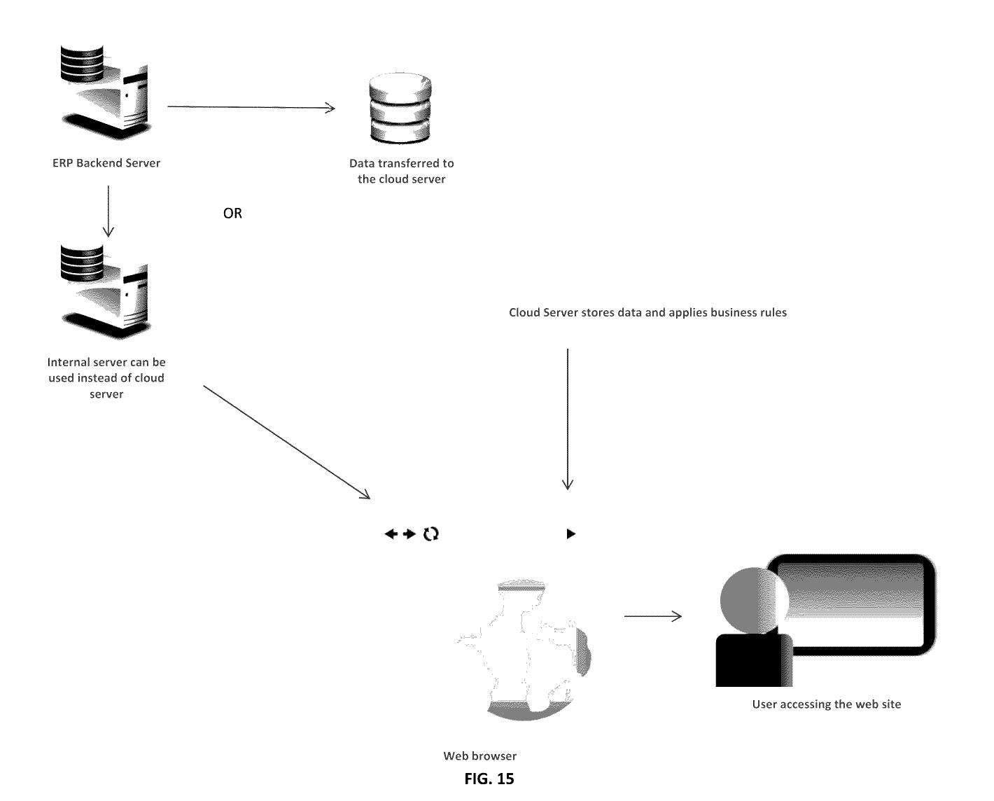

### BACKGROUND

EZCloud Sales (ECS)

Usually orders are placed by sales representative calling on their customers at a scheduled date and time to meet with the appropriate personnel to place an order and or by placing a call to the wholesaler call center to place an order, which can result in communication errors and very time consuming. This cloud base order system/process takes time and costly to both parties/sides. With this method of placing orders, the customer/end user is empowered to place order with their wholesalers from any palace and time globally 24×7 via a cloud b. This systems provides for a centralized location of all types of orders placed for the customer such as EDI, Facsimile, Host system, Mobile and Call-in orders this allows the customer/end users to modify an order just before the their respective cutoff time to place an order. This method can result in cost savings to both parties and very convenient for the end user.

### DETAIL

EZCloud Sales (ECS)

The embodiment of the system is to provide a cloud-based solution that will enable organizations to present their products to their customer in a powerful and easy-to-use manner while affording them the ability to do it in a controlled manner. The EZCloud Sales solution can be hosted in the cloud or hosted within an organization's IT infrastructure. It can be connected to and interacted with by virtually any standard internet connected device and will support all major web browsers.

The fundamental benefits of the system begin with its ability to administer and deploy disparate organizations unique business rules. These can encompass multiple aspects of distributor/vendor and customer interactions. The embodiment of the solution will enable the business to clearly display and enforce multiple items, including order cutoff times and delivery schedules. The system will prominently display what a company's cutoff time is. It can also not allow orders to be submitted for certain delivery days once a cutoff time has passed. The application will provide notification functionality to alert customers that a cutoff time is approaching, yet they have not submitted an order.

The solution will ensure customers only have access to delivery days that have been authorized for them by the company. This is accomplished by utilizing attributes from various calendars and schedules. The company may create a standard delivery calendar and assign corresponding days to certain customers. They could also apply a customer's calendar in an effort to limit days in which they would not be available to receive deliveries. The application can accommodate scheduling based on product or raw material procurement from suppliers as well. There are circumstances in which delivery day issues may still arise. The system is capable of addressing and modifying delivery dates that could be affected by holidays and unexpected interruptions.

Security and user access is critical to any cloud-based solution. The embodiment of the security setup is logical and user-friendly. It begins with grouping customer accounts accordingly. User Roles are created and maintained that will control what screens users may access and how they will interact with them. These roles are then assigned to appropriate users to grant or deny them corresponding access. Part of the interaction will be assessing whether or not to allow access to customer specific pricing and promotions. Another aspect will be to dictate whether or not a user is permitted to create orders for a single location, all locations, or only certain locations. While they are in the order entry screens, the system can tightly control what products they have access to order.

The application will encompass various types of entities, such as Customers, Items and Users. These entities will be a culmination of various attributes. The attributes will contain the detailed data associated with the entities. All of the information that is contained within the entities and attributes will be able to be searched, filtered and reported against. An additional aspect of entities will be that they will be able to archive and display high resolution images.

As customers interact with the system, organizations will have the option of flagging and presenting specific products, such as newly introduced ones, in a way that catches their customer's eye. End users will be able to track and utilize their current store inventories via the web interface. They will key it directly in to the system then those counts can be used by the application to present recommended orders based on proprietary sell-thru calculations that included weighted factors. The user would then review the suggested order and make any necessary modification prior to submitting it. End users will also have the ability to generate suggested orders based on a previous order, sales history and/or sales forecast.

Users will be able to created orders weeks in advance. Based on a company's set of individual business rules, a configurable number of weeks ahead will be available for them to select. To assist in streamlining this process, it embodies multiple aspects of the system. Users will have the ability to create ‘Order Templates.’ These templates may be used in a variety of ways, including assigning them to different days of the week or by selecting one as a standing/default order. This order template could be submitted on behalf of the customer, should they fail to submit an order prior a predefined cutoff time.

Logic has been built into the solution to ensure orders that are being submitted are accurate and best serve the needs of both, the customer and the vendor/distributor. The application will evaluate quantities that have been entered and check to see if they include decimal points where they shouldn't or have extraneous data that is either substantially higher or lower than what is typical. Based on business rules, organizations may apply and enforce minimum quantities and/or minimum dollar amounts to the orders prior to submission. They may also have the system calculate and automatically apply delivery surcharges based on the minimum quantities or dollar amounts ordered.

Once orders have been submitted, they will utilize the current date & time as the submission date & time. Business rules permitting, there will not need to be a delay or have them in a pending state as they will be done in near real-time. The system will then promptly send an email notification to the user that submitted it stating that it has been successfully submitted. Also based on a company's set of business rules, logic can exist to automatically allocate and send an additional notification to the user that the order has been processed and fulfilled. The orders will continue to be editable up to predefined cutoff days and times. The edit functionality can apply to all orders, regardless of input method. The current status of an order will be clearly conveyed to the end user throughout the process.

The embodiment of the application is to ensure orders are processed effectively and efficiently. To successfully do this, information must be presented to the end user throughout the process. There may be instances however, where a customer may still need to contact a company representative. Therefore, the organization's ‘Call Center’ contact number will be prominently displayed where appropriate. This will enable the customer to contact the company with any issues and/or an instance requiring a critical delivery. The system will also assist users by displaying help and directional information when the mouse cursor is place over certain objects.

Communication is key within any industry. In additional to all of the before mentioned, the solution is capable of utilizing various customer and product attributes to enable broad and limited based communications with customers via notifications. For instance, should an issue necessitate a product recall, the application can assist in facilitating the corresponding communications by allowing the company's internal personnel to search attributes for specific pieces of information, such as Lot Numbers, Product Ingredients, Sell By & Use By Dates, etc. To validate the items in question are correct, various checks & balances can be used, such as validating the item number, description, and or the Universal Product Code (UPC). Once the customer list has been established, notifications could be sent directing the customers to take the appropriate action.

### SUMMARY

EZCloud Sales (ECS) Summary

EZCloud Sales is a cloud-based solution that enables companies to present their products to their customers in a quick and easy manner—24 hours a day, 7 days a week, 365 days a year. The embodiment of the system is that it is an intuitive, highly configurable and powerful tool that will allow disparate organizations to control and enforce their unique set of business rules while servicing their customers. The web portal adds flexibility and utility to a company's sales, delivery and customer service programs by granting system access to key accounts. The customers gain benefit by having a solution that will enable them to efficiently create orders at any time utilizing a variety of tools and resources. It is accessible by virtually any internet connected device using any of the major web browsers.

Organizations will have control over what products individual customers have access to ordering along with their corresponding pricing structures. They will be able to clearly display and enforce order cutoff days and times. They will also be able to impose minimum order quantity and/or dollar amount criteria prior to users being able to submit orders. The company may choose to clearly communicate and impose surcharges as deemed appropriate. As the users interact with the system, authorized delivery days will be the only ones that they are allowed to submit orders for. The customers will however, be allowed to key orders for multiple weeks in advance, business rules permitting. Multiple calendars may be taken into consideration, including customer specific ones.

Customer interaction with the solution is quick and easy. The application can systematically limit users to a predefined account or group of accounts. Once the user logs in, they could be presented with new or emphasized items, based on a company's marketing strategy. They would then proceed to document their current store inventory, view order history, or create an order from scratch. Should they choose to key in their inventory, the system can utilize proprietary weight-based logic and present them with a suggested order. If the end user elects to view their order history then create a new one, the application can take into account and generate a suggested order based on it and a calculated sales forecast encompassing sell-thru variables. Or, they may create an order at-will and with no pre-populated suggestions. To ensure orders are accurate, the system incorporates logic to check for extraneous entries.

The users will have the ability to create, maintain and utilize order templates. These templates may be assigned to specific days of the week. One template could also be flagged as a ‘Default Order.’ It could be automatically submitted should a customer miss a potential cutoff day or time. In an effort to limit this, an automated notification could be triggered and sent reminding the customer that a cutoff time is approaching and they have not yet submitted an order. The order entry system will also present the users with all pertinent information associated with the items and the servicing entity, such as contact number, order status and detailed item attributes, including high resolution images.

Once an order has been submitted, the end user will receive a notification email stating that the order has been successfully submitted. Should business rules dictate, a separate notification email could be generated and sent stating that inventory has been allocated and the order will be fulfilled. Organizations will be able to offer centralized order edit functionality via the web portal. Once a user is logged into the system, they will quickly and easily have access to all pending orders regardless of their original method of input, including telephone, Mobile device order or EDI. They can then view and edit those orders, assuming none of the cutoff days or times have elapsed. The order criteria associated with surcharges, minimum quantities and minimum dollar amounts will remain in effect.

The system easily accommodates the tracking, searching, and reporting against attributes. These attributes can be held against customers, items and users. Once information has been collected and associated with these attributes, they can be used in conjunction with predefined application processes, reporting and communicating. For example, in the event a product recall needs to occur an internal employee could search for and notify all customers that may be affected by a specific group of items associated by Lot Number, Product ID, and Sell by Date, etc. that they had received a delivery of.

### DIAGRAM FIGURES

EZCloud Sales (ECS)
1. A computer-implemented method that applies limits as to what items a user/account may order and what prices and promotions are applicable and which UOMs can be ordered. The system displays only items information that the customer is authorized to.
2. A computer-implemented method of controlling order cutoff days according to product ordering schedules. Schedules include holidays and exceptions as well as exceptions defined by the customer. The user can only select delivery dates that are available and is prevented from submitting an order/update for a date that corresponds to a cutoff time that has already passed. E-mail alert and onscreen text are used to remind the customer if the cutoff time is approaching and customer has not submitted an order.
3. A computer-implemented method that identifies new products on the website, show a large and high resolution image when the user clicks on a thumbnail image, and displays product information including barcodes.
4. User may view sales history and create orders from past orders in sales history by using Re-Order.
5. User may take store inventory and it can be used to generate a new order based on sales history and past store inventory, current store inventory, and forecast calculation.
6. A computer-implemented method that presents Standing/Default orders based on the day of the week. This can be used to create default orders automatically or be adjusted by the customer for each delivery date.
7. A computer-implemented method that provides a central location for end users to access existing orders that have been placed into the system regardless of the input method used. End users will be able to update/modify orders.
8. A computer-implemented method that will control an order submission based on a minimum order quantity and/or amount. A message will be presented to the end user stating that the minimum order has not been reached. An optional surcharge can be applied if minimum order was not reached.
9. A computer-implemented method that prominently displays a Call Center number for customers requiring any assistance or for critical delivery changes after regular order cutoff times.
10. A computer-implemented method that will allow for the creation and maintenance of order templates.
11. A computer-implemented method that will promptly send a notification email to the end user submitting an order.
12. A computer-implemented function that enables users to create orders for multiple locations as well as an individual one.
13. A computer-implemented method that clearly communicates the current status of an order.
14. A computer-implemented method that employs user roles to grant or deny access to the system and functions within it.
15. A computer-implemented product that may be hosted as a cloud-based solution or within an organization.

What is claimed:

1. A computer-implemented method that applies a limit as to what items a user/account may order, whose application logic encompassing and utilizing disparate organizations individual business rules and requirements to control access to predefined groupings of items, including, but not limited to, primary account information as well as their individual attributes, primary item information and their corresponding attributes; the information that's associated with accounts and items are from a database connection to a company's ERP system, then stored on and accessed via a cloud-based solution server that contains the data that is used and the logic that creates the limiting control function, and presents to the end-user by not displaying items they are not authorized to order.

2. A computer-implemented method that allows users access to customer-specific pricing and promotions in a cloud-based solution employed to facilitate limited access to an organization's pricing and promotional information based on their business rules as well as certain attributes of the customers, and presented to the end user taking into account weighted factors via the cloud-based solution with a database that is connected to a company's existing ERP or back end system and accessed by the end user via a web interface.

3. A computer-implemented method that employs user roles to grant or deny access to the system and functions within it in a cloud-based solution based on a company's set of business rules and the individual users that exist within the system containing various attributes, including but not limited to assigned user roles which are assigned depending on their necessary usage of the system to allow them access to view, add or edit information at varying levels, and for multiple customer or locations.

4. The computer-implemented method of claim 14, further comprising the ability for the archival and presentation of large and high resolution images, on a cloud-based solution server made up in part of a database that will hold high resolution images which are joined to Items via unique identifiers, and the items themselves will be provided to the cloud-based solution server via a database connection to a company's ERP or back end system, and the images will be accessible to the end user via a web interface, for the user to interact with by performing a mouse click to view enlarged and high resolution images which provides the end user with additional product information and attributes.

5. The computer-implemented method of claim 14, further comprising the flagging and presenting of recently introduced products to the end user, of items contained within an organizations ERP or back end system that are communicated to a cloud-based solution server via a database connection that provide the end user with a web based interface allowing them to interact with the items and their attributes, and based on a company's individual business rules, the method flags newly introduced items and presents these items to the end user in a fashion in which they are emphasized.

6. The computer-implemented method of claim 14, further comprising the ability to generate a product order based on the sales history of an account within an ERP system, and that information will be communicated to a cloud-based solution server via a database connection, with the history viewable by the end user for reference via a web interface, and with the use of weighted factors allow the users to generate an order based on items that are included with their individual sales history.

7. The computer-implemented method of claim 14, further comprising the ability for the end users to document inventory and utilize the information during an order creation process via a web interface, with multiple options for the end users for keying the current inventory quantities of items within various in-house locations, and the system will record these numbers and then summarize a total on-hand quantity of each item which can be used by the order procedure during the order creation process, and the inventory levels and order information will be stored and communicated to a back end or ERP system via a cloud-based solution server which will include a presentation layer for the end user to interact with via a website and a database that holds the information that will be displayed and edited.

8. The computer-implemented method of claim 14, further comprising the ability to calculate the sell-thru of individual products based on weighted factors and provide the end user with a suggested order of those products housed within a company's ERP or back end system that are communicated to a cloud-based solution server via a database connection including product attributes and present the items to the end user via a web interface, allowing the users to select an order creation method that incorporates the sell-thru data.

9. The computer-implemented method of claim 14, further comprising current date and time when submitting orders, and the cloud-based solution server will hold and present information from within its own database, allowing the end user to interact with that data via a web interface, and based on a company's individual business rules, for orders to be submitted to an ERP or back end system immediately without tangible delay or pending state, utilizing a direct database connection to communicate the orders and their associated attributes to the back end or ERP system.

10. The computer-implemented method of claim 20, further comprising the ability for the end user to select a specific delivery date, when applicable and from available delivery dates, taking into consideration a company's business rules and present available dates via a website on a cloud-based solution server which will communicate with an organization's ERP or back end system via a database connection and based on the attributes of the company and account to limit which delivery dates may be available to the end user.

11. The computer-implemented method of claim 14, further comprising the ability for the end users to create orders weeks in advance, via a web interface on a cloud-based solution server including a database to hold and communicate the attributes of orders to an ERP or back end system, and based on a company's business rules, logic and a configurable value for the number of weeks ahead an order may be created.

12. The computer-implemented method of claim 14, further comprising Standing/Default orders based on day of week, incorporating the attributes of individual customers and a company's business rules in identifying their capacity of having and utilizing default orders based on day of week, with different defaults based on the day of the week and for each day of week, and the ability to update the orders as needed prior to submitting for processing and delivery via a web interface and the data housed on a cloud-based solution server which communicates with a company's back end or ERP via a database connection to submit the orders for final processing.

13. The computer-implemented method of claim 14, further comprising the ability to generate orders based on sales forecasts, taking into account previous sales history of a product within a customer's location as well as the company's business rules, product availability and additional weighted factors associated with the products and the customers, and configurable time frame for sales history consideration and present the suggested order via a web interface which is built from information held within a cloud-based solution that communicates with a company's back end or ERP systems database for the sales history, customer and item information in an effort to create the best forecast based order incorporating its calculation.

14. A computer-implemented method that provides a central location for end users to create new orders as well as manage existing orders that have been placed into the system regardless of the input method used, accessed via a cloud-based solution server, which will have a database connection to a company's back end or ERP system, and can be configured to have the data be as up-to-date as desired based on a company's business rules, taking into account an individual customers attributes, and all of their outstanding orders, including but not limited to, phone or fax (manually keyed), EDI or online, presented via a web interface, allowing end users update/modify orders via this interface should the company business rules allow it.

15. The computer-implemented method of claim 14, further comprising the ability to modify/update an order prior to a predefined cutoff date and/or time utilizing factors from customers, products and the company's business rules, and logic to present the end user with only orders that may be updated or modified via a web portal accessible 24×7×365 and the data housed in a cloud-based solution server which stays in sync with the company's ERP or back end system via a database connection and communicates the revised orders to the host system for processing.

16. The computer-implemented method of claim 14, further comprising requirements that will control an order submission based on a minimum order quantity, taking into consideration an organization's business rules to enforce a minimum quantity ordered prior to allowing the end user to submit a newly created order, or prior to submitting a previously created order that has been modified but no longer meets the criteria, taking into account attributes of individual customers and items, and a message will be presented to the end user if the minimum order quantity has not been reached, via a web interface that uses information from a cloud-based solution server with a database connection to the company's ERP or back end system to submit orders and to allow access to existing ones.

17. The computer-implemented method of claim 14, further comprising requirements that will control an order submission based on a minimum dollar amount, taking into consideration an organization's business rules to enforce a minimum dollar amount ordered prior to allowing the end user to submit a newly created order, or prior to submitting a previously created order that has been modified but no longer meets the criteria, taking into account attributes of individual customers and items, and a message will be presented to the end user if the minimum dollar amount has not been reached, via a web interface that will use information from a cloud-based solution server with a database connection to the company's ERP or back end system to submit orders and allow access to existing ones.

18. The computer-implemented method of claim 14, further comprising the ability to calculate and include a shipping surcharge based on a minimum quantity ordered, based on an organization's set of business rules, and will apply to newly created orders as well as ones that are being updated or modified including orders that have been modified and no longer meet the criteria for a surcharge, taking into account various attributes of customers and items and the surcharge applicability, and the surcharge will be clearly displayed as part of the order to ensure the end user is aware of it, via a web interface that is attached to a cloud-based solution server with a database connection to a company's ERP or back end system.

19. The computer-implemented method of claim 14, further comprising the ability to calculate and include a shipping surcharge based on a minimum dollar amount ordered, based on an organization's set of business rules, and will apply to newly created orders as well as ones that are being updated or modified including orders that have been modified and no longer meet the criteria for a surcharge, taking into account various attributes of customers and items and the surcharge applicability, and the surcharge will be clearly displayed as part of the order to ensure the end user is aware of it, via a web interface that is attached to a cloud-based solution server with a database connection to a company's ERP or back end system.

20. A computer-implemented method that ensures customers only have access to authorized delivery days when creating new, and modifying existing orders via a web interface utilizing information that is included within the database of a cloud-based solution server which will have a database connection to a company's ERP or back end system and apply its business rules associated with delivery days accordingly and will be configurable and additional customer attributes will be taken into consideration when displaying the status of individual days, with days that are not available grayed out.

21. The computer-implemented method of claim 14, further comprising limits on an end user's ability to enter and submit new orders after a predefined cutoff date and/or time utilizing logic that will control the order create function to limit deliveries to predefined schedules based on an individual company's business rules and attributes associated with the products that are on the order and the customer that is placing the order, so the end user cannot submit an order after a cutoff time has passed, and will be presented with a message stating that the time to submit the order for the selected delivery date has passed and the end user would then have to select a new available delivery date on the web portal which utilizes information that is contained within the database of a cloud-based solution server with a connection to a company's back end or ERP server.

22. The computer-implemented method of claim 14, further comprising a prominently displayed Call Center number for customers requiring critical deliveries to allow an organization to clearly display a contact number of their choosing for customers to use in a scenario that would necessitate a critical delivery that may be outside of normal business rules, and this field will be configurable based on the organizations and will be part of the overall cloud-based solution.

23. A computer-implemented logic that assists with the limiting of extraneous orders implemented within a cloud-based solution that takes the embodiment of an order that has been keyed and applies proprietary logic to it in an effort to prevent users from submitting orders that may contain obvious or accidental errors, utilizing logic which evaluates the data entered by the end user and checks it for various potential issues, including but not limited to, invalid decimal placement and quantities that far exceed historical or typical orders, and the information used in the scenario may include custom algorithms as well as taking into account attributes and sales history of customers and products that will be housed within a company's ERP system which then communicated with a cloud-based server enabling the interaction with the end user.

24. The computer-implemented method of claim 14, further comprising the ability for end users to review products and quantities ordered from previous days or weeks in an effort to assist them with creating efficient orders via a website hosted on a cloud-based server that allows the end user to review historical information then apply that knowledge to current and future orders, taking into account the embodiment of the unique customer's sales history and corresponding trends, so the user can then make the most informed decisions when generating their orders which will be submitted via the cloud-based solution and be processed and sent to an organization's back end or ERP system via a database connection.

25. The computer-implemented method of claim 14, further comprising the ability for an end user to reorder products based on a previous order, based on an organization's individual business rules, so the user may select a previous order as a template for a new order and the new order would then be populated with the corresponding items and their associated quantities, and the user may modify the new order as needed and then submit it via a cloud-based solution presenting a web interface to the end user, and the order will be processed from the cloud based server to the company's ERP system through a database connection.

26. The computer-implemented method of claim 14, further comprising the ability to alert an end user to the fact that a scheduled cut off time is approaching and they have yet to submit an order utilizing an organization's business rules and incorporating the customer's attributes and configurable value and whether or not that account has a cutoff time approaching and whether the customer had submitted an order prior to or within a set time period, with an email alert that can be generated and sent to the end user.

27. The computer-implemented method of claim 14, further comprising the ability for the creation and maintenance of order templates based on a company's business rules and customer attributes, and these templates will be created and maintained within a cloud-based solution that will be accessed by a web portal which will depend on a proprietary database to hold and process the orders via a communications protocol established between the cloud-based database and a company's back end or ERP system.

28. The computer-implemented method of claim 12, further comprising the ability for a predetermined order to be submitted on behalf of a customer, utilizing an organizations set of business rules and customer attributes, and established policies that may allow for a default order being submitted should a predetermined cutoff time elapse, and the default order will be submitted to a cloud-based server that is connected to a company's back end or ERP system via a database connection.

29. The computer-implemented method of claim 14, further comprising sending a prompt notification email to the end user after submitting an order utilizing a cloud-based solution to route the order to the back end or ERP system in near real-time once the order has been submitted and a logical process to generate a notification that will be emailed to the user that completed the order creation process, to the email address setup on the user's profile.

30. The computer-implemented method of claim 14, further comprising the ability to allocate inventory and notify the end user of the order fulfillment, in which a user will generate and submit an order via a web interface utilizing a cloud-based application and database to process the order and route it to a company's ERP or back end system via a database connection, and then the system will allocate the appropriate items to the order based on its contents, and upon successful completion, communicate back to the cloud-based server which will then send an email notification to the user that submitted the order.

31. The computer-implemented method of claim 14, further comprising methods to accommodate holidays and unexpected interruptions in delivery service, based on an individual company's set of business rules, standard holidays, and delivery interruption procedures in place that can be accommodated by the cloud-based solution architecture which allows appropriate system users to set the status of individual days, and based on the status of those days, allow certain internal users the ability to override the predefined status and modify delivery dates for customers and deliveries by moving them forward or back to ensure efficient scheduling and a high level of customer service.

32. A computer-implemented function that enables users to create orders for multiple locations as well as an individual one, based on a company's business rules and individual customer and user attributes, with certain customers and individual users may be limited to creating and submitting orders for only their location, whereas other users may have the authority to create and submit orders for multiple accounts or locations, and the application will validate a user's security settings to ensure they are authorized to create orders for multiple locations or accounts, and those orders are then routed to a company's ERP or back end system in near real time via a database connection.

33. The computer-implemented method of claim 14, further comprising the ability to access a cloud-based solution via virtually any standard internet connected device and all major web browsers, and allow end users to perform a variety of functions that is necessary to placing an efficient order, and those functions may be limited or restricted based on a company's set of business rules and/or individual user's or account's attributes, and the cloud-based solution will have a database connection to a company's ERP or back end system, and depending on how the end user interacts with the solution, certain information, including orders will be communicated to the back end system for processing.

34. The computer-implemented method of claim 14, further comprising the ability to be hosted as a cloud-based solution or within an organization, taking into account disparate company business rules, within an organizations technical infrastructure, taken into consideration that if installing it locally, a server with the appropriate data base, and the peripheral that will be necessary to be accessible via the internet, and regardless of the implementation chosen, the embodiment of the solution will offer the end user a powerful and easy-to-use web interface which will provide the organization a strategic utility that presents a dynamic and intelligent frontend for their products and allows the company to control how their customers will interact with them.

35. A computer-implemented method that allows companies to deploy and enforce disparate business rules, based on different organizations' varying business rules to enable companies to apply and enforce those rules in correlation with attributes associated with products, customers and users, also taking into account individual customers regions and which warehouses services them, with weighted factors employed to direct customer's behavior towards complying with the company's set of business rules, and the rules are allowed to be custom and sophisticated.

36. The computer-implemented method of claim 14, further comprising the ability to enable entities to have various pieces of information, that will be interacted with via a website, which will rely on a database that communicates with a company's ERP or back end system and the solution may be could-based or hosted within an organization to based on the information within the system, accommodate various product, customer and user attributes, and some of the attributes will be considered primary or required for consistent and proper usage.

37. The computer-implemented method of claim 14, further comprising the ability to search against multiple areas of information and the system may be installed locally or hosted as a cloud-based solution that communicates between its database and a company's ERP or back end system, and depending on a company's set of business rules, allow users to search for items within the solution via a web interface utilizing multiple search criteria.

38. The computer-implemented method of claim 14, further comprising the ability to present users with pertinent information when the cursor is placed over a specified item in an effort to assist end users with the usage of the cloud-based solution, and the information within these mouse-over tips will vary based on the function of the individual items, and certain mouse-over tips may also include event notification information such as ‘last updated by.’

39. The computer-implemented method of claim 14, further comprising methods that clearly communicates the current status of an order on a cloud-based solution that allows end users to create, review and submit orders based on a company's set of business rules and attributes associated with the various items and orders so the system will clearly display the status of an order and that status of an order will change based on the interaction of the end user.

40. (canceled)

41. (canceled)

42. The computer-implemented method of claim 14, further comprising the ability to track, display and utilize a product's Universal Product Code (UPC) on a cloud-based solution that will enable users to view and interact with these UPC Codes via keying, scanning or imaging (OCR), and the solutions will be comprised of a database and an application layer and will communicate data between itself and a company's back end or ERP system.

43. The computer-implemented method of claim 14, further comprising the ability to facilitate the tracking and utilization of a products Unit of Measure (UoM), based on an organization's unique set of business rules, to utilize a products UoM in various ways including for pack-size, number of units, color and so forth, and these unique values could then be included in creating complex pricing if deemed appropriate, and they would also be useful during the routing, loading and delivery processes, and the logic within the solution will be able to convert the UoMs as necessary taking into consideration orders that may have been submitted using one UoM and how it may be impacted based on schedules and availability of the products consisting of varying UoMs.

44. The computer-implemented method of claim 20, further comprising the ability of applying a customer's scheduling calendar effectively based on a company's set of business rules, customer specific scheduling calendars and their attributes and establish valid and available days that they may be serviced, and end users will interact with a cloud-based solution that utilizes these calendars in an operational manner, in which days that are available to the end user will be ones that they can interact with, and days that are not available to the end user will be grayed out, and also allow internal users to modify and adjust delivery schedules at a customer level accordingly, on a cloud-based solution encompassing its own database that will have a connection to a company ERP or back end system.
